(19) United States
(12) Patent Application Publication
(10) Pub. No.: US 2020/0021679 A1
(43) Pub. Date: Jan. 16, 2020

(54) VEHICLE AND CONTROL METHOD THEREOF

(71) Applicants: Hyundai Motor Company, Seoul (KR); Kia Motors Corporation, Seoul (KR)

(72) Inventors: Jeong-gi Yun, Seoul (KR); Jinwon Park, Seoul (KR); Seokgyu Kim, Seongnam, Gyeonggi-do (KR)

(21) Appl. No.: 16/205,744

(22) Filed: Nov. 30, 2018

(30) Foreign Application Priority Data
Jul. 16, 2018 (KR) 10-2018-0082179

(51) Int. Cl. H04M 1/725; H04W 76/14; H04W 4/029; H04W 4/02; H04W 4/48; H04L 9/08; H04W 12/04

(52) U.S. Cl. CPC H04M 1/72533; H04W 76/14; H04W 4/029; H04W 12/0401; H04W 4/48; H04L 9/085; H04W 12/04031; H04W 4/023

(57) ABSTRACT

A vehicle may include a positioning communication module configured to receive a positioning signal of a portable terminal through a data channel; and a main communication module configured to perform pairing with the portable terminal and to transmit an encryption key shared with the portable terminal to the positioning communication module. The main communication module may be further configured to receive an address of the data channel encrypted with the encryption key from the portable terminal and to transmit the encrypted address to the main communication module, and the positioning communication module may be further configured to decrypt to the encrypted address using the encryption key received from the main communication module and to receive the positioning signal of the portable terminal through the data channel having the decrypted address.

### CROSS-REFERENCE TO RELATED APPLICATION

This application is based on and claims priority under 35 U.S.C. § 119 to Korean Patent Application No. 10-2018-0082179, filed on Jul. 16, 2018 in the Korean Intellectual Property Office, the disclosure of which is incorporated by reference herein in its entirety.

### BACKGROUND

### 1. Technical Field

The present disclosure relates to a vehicle and a control method thereof and, more specifically, to a vehicle that securely receives a positioning signal from a portable terminal, and a control method thereof.

### 2. Description of the Related Art

A conventional remote control system for a vehicle enables a driver to perform remote functions such as opening and closing a door of the vehicle from the outside and starting the vehicle without inserting a key into the ignition. A smart card or a “FOB” capable of wireless communication is often used as the remote control system.

Recently, various handheld-based portable terminals for vehicle control have been developed. In this case, the vehicle receives a positioning signal from the portable terminal and estimates the position of the portable terminal based on the positioning signal. However, a risk of the communication being hacked exists as the positioning signal is transmitted over a public channel.

### SUMMARY

It is an aspect of the present disclosure to provide a vehicle that securely receives a positioning signal from a portable terminal, and a control method thereof.

Additional aspects of the present disclosure will be set forth in part in the description which follows and, in part, will be apparent from the description, or may be learned by practice of the disclosure.

In accordance with embodiments of the present disclosure, a vehicle may include: a positioning communication module configured to receive a positioning signal of a portable terminal through a data channel; and a main communication module configured to perform pairing with the portable terminal and to transmit an encryption key shared with the portable terminal to the positioning communication module. The main communication module may be further configured to receive an address of the data channel encrypted with the encryption key from the portable terminal and to transmit the encrypted address to the main communication module, and the positioning communication module may be further configured to decrypt to the encrypted address using the encryption key received from the main communication module and to receive the positioning signal of the portable terminal through the data channel having the decrypted address.

The vehicle may further include a controller configured to authorize remote control of the vehicle. The positioning communication module may transmit the positioning signal to the main communication module, the main communication module may estimate a position of the portable terminal based on the positioning signal, and the controller may authorize the remote control of the vehicle by the portable terminal based on the estimated position of the portable terminal.

The vehicle may further include a plurality of positioning communication modules provided in the vehicle. The plurality of positioning communication modules may receive a plurality of positioning signals, respectively, and transmit the plurality of positioning signals to the main communication module, and the main communication module may estimate a position of the portable terminal based on the plurality of positioning signals.

The main communication module may estimate the position of the portable terminal using a triangulation method.

The controller may authorize the remote control of the vehicle by the portable terminal when the estimated position of the portable terminal is within a preset reference distance from the vehicle.

The main communication module may perform pairing with the portable terminal to generate the encryption key, and may share the encryption key with the portable terminal.

The controller may generate an encryption key and transmit the encryption key to the main communication module when the portable terminal and the vehicle are paired, and the main communication module may share the encryption key with the portable terminal.

The main communication module may receive a door lock signal from the portable terminal, and the controller may control operation of the vehicle causing a door lock of the vehicle to lock or unlock based on the door lock signal when the remote control of the vehicle by the portable terminal is authorized.

The vehicle may further include an input unit configured to receive a lock or unlock command of a door lock of the vehicle. The controller may control operation of the vehicle causing the door lock to lock or unlock based on the lock or unlock command when the vehicle control of the portable terminal is authorized.

Furthermore, in accordance with embodiments of the present disclosure, a vehicle may include: a positioning communication module configured to receive a positioning signal of a portable terminal through a data channel, and a main communication module configured to perform pairing with the portable terminal and to store an encryption key shared with the portable terminal. The main communication module may be further configured to receive an address of the data channel encrypted with the encryption key from the portable terminal, to decrypt the encrypted address using the encryption key, and to transmit the decrypted address to the positioning communication module, and the positioning communication module may be further configured to receive the positioning signal of the portable terminal through the data channel having the decrypted address.

The vehicle may further include a controller configured to authorize remote control of the vehicle. The positioning communication module may transmit the positioning signal to the main communication module, the main communication module may estimate a position of the portable terminal based on the positioning signal, and the controller may authorize the remote control of the vehicle by the portable terminal based on the estimated position of the portable terminal.

The vehicle may further include a plurality of positioning communication modules provided in the vehicle, and the plurality of positioning communication modules may receive a plurality of positioning signals, respectively, and transmit the plurality of positioning signals to the main communication module. The main communication module may estimate a position of the portable terminal based on the plurality of positioning signals.

The main communication module may estimate the position of the portable terminal using a triangulation method.

The controller may authorize the vehicle control of the portable terminal when the portable terminal is within a preset reference distance from the vehicle.

The main communication module may perform the pairing with the portable terminal to generate the encryption key and share the encryption key with the portable terminal.

The controller may generate an encryption key and transmit the encryption key to the main communication module when the portable terminal and the vehicle are paired, and the main communication module may share the encryption key with the portable terminal.

Furthermore, in accordance with embodiments of the present disclosure, a method of controlling a vehicle may include: performing, by a main communication module, pairing with a portable terminal; receiving, by a positioning communication module, an encryption key shared with the portable terminal from the main communication module; receiving, by the main communication module, an address encrypted with the encryption key from the portable terminal; receiving, by the positioning communication module, the encrypted address from the main communication module; decrypting, by the positioning communication module, the encrypted address using the encryption key received from the main communication module; and receiving, by the positioning communication module, a positioning signal from the portable terminal through a data channel having the decrypted address.

The method may further include authorizing, by a controller, remote control of the vehicle by the portable terminal when the positioning signal can be decrypted.

The method may further include estimating, by the main communication module, a position of the portable terminal based on a plurality of positioning signals generated by a plurality of positioning communication modules, respectively, provided in the vehicle.

The method may further include authorizing, by the controller, the remote control of the vehicle by the portable terminal when the portable terminal is within a preset reference distance from the vehicle.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is an external view of a vehicle according to embodiments of the present disclosure;

FIG. 2 is a view illustrating an internal view of a vehicle according to embodiments of the present disclosure;

FIG. 3 is a control block diagram of a vehicle system according to embodiments of the present disclosure;

FIGS. 4 to 8 are schematic views for explaining a signal transmission/reception process between a vehicle and a portable terminal; and

FIG. 9 is a flowchart of a method of controlling a vehicle according to embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure.

Like reference numerals refer to like elements throughout this specification. This specification does not describe all components of embodiments, and general information in the technical field to which the present disclosure belongs or overlapping information between the embodiments will not be described. The terms “portion,” “module,” “member,” and “block” as used herein, may be implemented as software or hardware, and according to embodiments, a plurality of “portions”, “modules”, “members”, or “blocks” may be implemented as a single component, or a single “portion,” “module,” “member,” or “block” may include a plurality of components.

Throughout this specification, when a portion is “connected” to another portion, this includes the case in which the portion is indirectly connected to the other portion, as well as the case in which the portion is directly connected to the other portion, and the indirect connection includes a connection through a wireless communication network.

Also, it will be understood that the terms “includes,” “comprises,” “including,” and/or “comprising” when used in this specification, specify the presence of a stated component, but do not preclude the presence or addition of one or more other components.

It will be understood that, although the terms “first,” “second,” etc. may be used herein to describe various components, these components should not be limited by these terms. These terms are only used to distinguish one component from another.

It is to be understood that the singular forms “a,” “an,” and “the” include plural referents unless the context clearly dictates otherwise.

Reference numerals used in operations are provided for convenience of description, without describing the order of the operations, and the operations can be executed in a different order from the stated order unless a specific order is definitely specified in the context.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller (or “vehicle controller”). The term “controller” may refer to a hardware device that includes a memory and a processor. The memory is configured to store program instructions, and the processor is specifically programmed to execute the program instructions to perform one or more processes which are described further below. The controller may control operation of units, modules, parts, devices, or the like, as described herein. Moreover, it is understood that the below methods may be executed by an apparatus comprising the controller in conjunction with one or more other components, as would be appreciated by a person of ordinary skill in the art.

Hereinafter, embodiments of the present disclosure will be described with reference to the accompanying drawings.

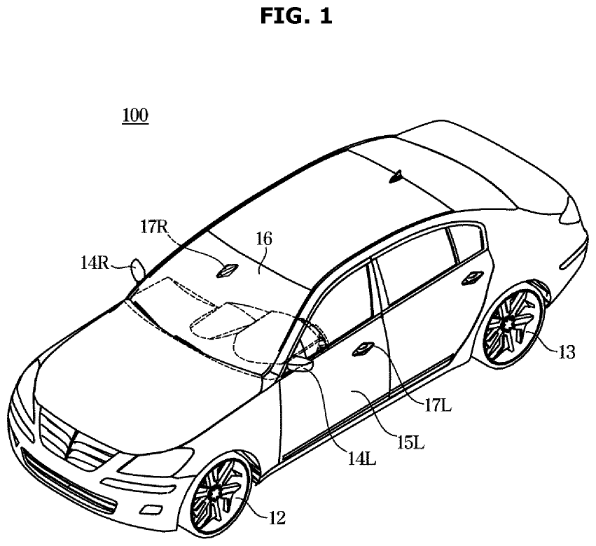

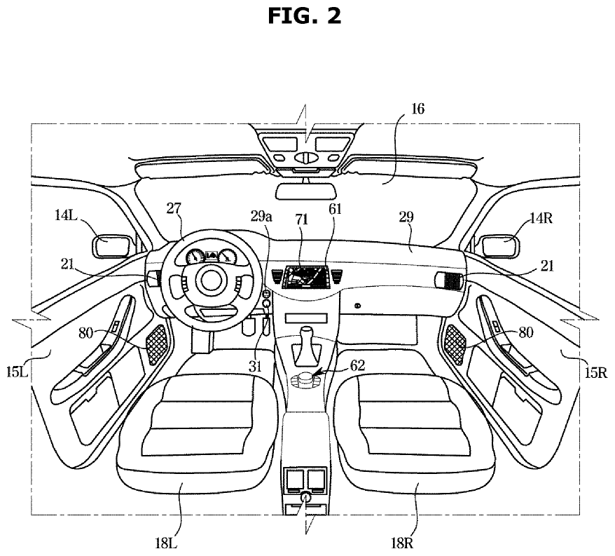

FIG. 1 is an external view of a vehicle according to embodiments of the present disclosure, and FIG. 2 is a view illustrating an internal view of the vehicle according to embodiments of the present disclosure.

Referring first to FIG. 1, a vehicle 100 includes wheels 12 and 13 for moving the vehicle 100, doors 15L and 15R (refer to FIG. 2) for shielding the inside of the vehicle 100 from the outside, a front glass 16 for providing a driver inside the vehicle 100 with a field of view ahead of the vehicle 100, and side mirrors 14L and 14R for providing the driver inside the vehicle 100 with a field of view behind the vehicle 100.

The wheels 12 and 13 include the front wheels 12 provided at a front of the vehicle 100 and the rear wheels 13 provided at a rear of the vehicle 100. A driving device (not shown) provided inside the vehicle 100 provides a rotational force to the front wheels 12 or the rear wheels 13 so that the vehicle 100 moves forward or backward. The driving device may employ an engine that generates a rotational force by burning fossil fuel, or a motor that generates a rotational force by receiving power from a capacitor.

The doors 15L and 15R are rotatably provided on the left and right sides of the vehicle 100 so that a driver or a passenger may ride inside the vehicle 100 when the vehicle 100 is opened and the inside of the vehicle 100 is shielded from the outside when the vehicle 100 is closed. In addition, handles 17L and 17R for opening and closing the doors 15L and 15R may be provided on the outside of the vehicle 100.

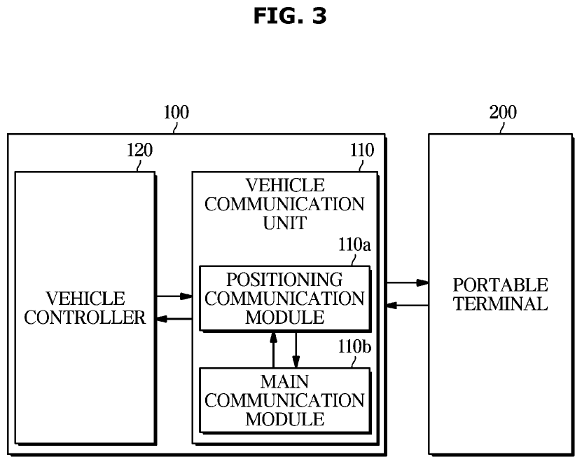

When a touch sensing unit of the doors 15L and 15R senses the touch input of a user while the user is holding a portable terminal 200 (refer to FIG. 3) registered in the vehicle 100, the vehicle 100 performs authentication with the portable terminal 200 through a wireless communication network, and when the authentication is completed, the door lock of the vehicle 100 is released and the door 15L or 15R may be opened by the user pulling the handle 17L or 17R. Herein, the user includes not only the driver but also the passenger on board the vehicle 100, and refers to a person having the portable terminal 200.

The front glass 16 is provided on a front upper side of a main body of the vehicle 100 so that the driver inside the vehicle 100 may obtain visual information in front of the vehicle 100, and is also called a windshield glass.

The side mirrors 14L and 14R include the left side mirror 14L provided on the left side of the vehicle 100 and the right side mirror 14R provided on the right side of the vehicle 100, and enable the driver inside the vehicle 100 to obtain visual information on the sides and rear of the vehicle 100.

In addition, the vehicle 100 may include sensing apparatuses such as a proximity sensor for sensing rear or side obstacles or other vehicles, a rain sensor for sensing rainfall and precipitation, and a camera.

It is understood that the external view of the vehicle 100 as described above and illustrated in FIG. 1 is provided merely for demonstration purposes, and therefore does not limit the scope of the present disclosure.

Referring next to FIG. 2, an AVN (Audio Video Navigation) display 71 and an AVN input unit 61 may be provided on a central area of a dashboard 29. The AVN display 71 may selectively display at least one of an audio screen, a video screen, and a navigation screen, as well as various control screens related to the vehicle 100 or screens related to additional functions.

The AVN display 71 may be implemented as an LCD (Liquid Crystal Display), an LED (Light Emitting Diode), a PDP (Plasma Display Panel), an OLED (Organic Light Emitting Diode), a CRT (Cathode Ray Tube), and the like.

The AVN input unit 61 may be provided on an area adjacent to the AVN display 71 as a hard key type, and may also be provided in the form of a touch panel on the front of the AVN display 71 when the AVN display 71 is implemented as a touch screen type.

A center input unit 62 of a jog shuttle type may be provided between a driver's seat 18L and a passenger seat 18R. The user may input a control command in such a manner that the center input unit 62 is turned, pressed, or pushed in the up, down, left, or right direction.

The vehicle 100 may be provided with a sound output unit 80 capable of outputting sound, and the sound output unit 80 may be a speaker. The sound output unit 80 may output sounds necessary for performing an audio function, a video function, a navigation function, and other additional functions.

A steering wheel 27 is provided on the dashboard 29 at a side of the driver's seat 18L, and a key groove 29a capable of inserting a FOB (not shown) is formed on an area adjacent to the steering wheel 27. When the FOB is inserted into the key groove 29a or the authentication between the portable terminal 200 and the vehicle 100 is completed through a wireless communication network, the FOB or the portable terminal 200 and the vehicle 100 may be connected.

The dashboard 29 may be provided with a start button 31 for on/off-controlling the start of the vehicle 100. Authentication is performed by inserting the FOB into the key groove 29a or transmitting and receiving authentication data (hereinafter referred to as “token”) to and from a vehicle local area communication module provided near the start button 31 and a terminal local area communication module of the portable terminal 200 registered in the vehicle 100, and the start of the vehicle 100 can be turned on by pressing the start button 31 by the user.

In addition, the vehicle 100 is provided with an air conditioner to perform both heating and cooling, and it is possible to control the temperature inside the vehicle 100 by discharging the heated or cooled air through air vents 21.

It is understood that the internal view of the vehicle 100 as described above and illustrated in FIG. e is provided merely for demonstration purposes, and therefore does not limit the scope of the present disclosure.

FIG. 3 is a control block diagram of a vehicle system according to embodiments of the present disclosure.

As shown in FIG. 3, the vehicle system includes the vehicle 100 and the portable terminal 200.

The vehicle 100 and the portable terminal 200 may be connected through a local area network. Herein, the local area network may include, but is not limited to, wireless LAN, Wi-Fi, Bluetooth, Zigbee, WFD (Wi-Fi direct), UWB (ultra wideband), IrDA (infrared data association) BLE (Bluetooth Low Energy), NFC (Near Field Communication), and RFID (radio frequency identification).

According to embodiments of the present disclosure, the vehicle 100 may perform pairing with the portable terminal 200 via a Bluetooth communication network, and may transmit and receive a wireless signal to and from the portable terminal 200 through the Bluetooth communication network when the pairing is completed.

The pairing is a process of registering the information of the portable terminal 200 in the vehicle 100, and the vehicle 100 may share the encryption key with the portable terminal 200 by the pairing process.

When the pairing is completed, the vehicle 100 and the portable terminal 200 may transmit and receive the encrypted data using the mutually shared encryption key.

In order for the vehicle 100 and the portable terminal 200, which have already completed the pairing, to transmit and receive data through a specific data channel, the portable terminal 200 may first transmit the address of the data channel encrypted with the encryption key, the vehicle 100 may determine the address of the data channel by decrypting the encrypted address using the shared encryption key, and the vehicle 100 and the portable terminal 200 may perform communication through the data channel having the determined address.

The vehicle 100 and the portable terminal 200 according to embodiments of the present disclosure may transmit and receive the positioning signals of the portable terminal 200, which are used by the vehicle 100 to estimate the position of the portable terminal 200, through the data channel. To this end, the vehicle 100 may include a vehicle communication unit 110, a vehicle storage unit 130, and a vehicle controller 120.

The vehicle communication unit 110 may include a positioning communication module 110a for receiving a positioning signal for estimating the position of the portable terminal 200, and a main communication module 110b for performing pairing with the portable terminal 200.

The positioning communication module 110a according to embodiments of the present disclosure may receive the encryption key from the main communication module 110b when the main communication module 110b completes the pairing with the portable terminal 200.

Reception of the encryption key by the positioning communication module 110a may include not only receiving the encryption key transmitted from the main communication module 110b but also snipping the encryption key stored in the main communication module 110b.

The positioning communication module 110a may receive the positioning signal of the portable terminal 200 through a specific data channel. In order to determine the address of the specific data channel, the positioning communication module 110a may receive the encrypted address received from the portable terminal 200 by the main communication module 110b from the main communication module 110b, or may snip the encrypted address stored in the main communication module 110b.

The positioning communication module 110a may decrypt the encrypted address using the encryption key received from the main communication module 110b, and receive the positioning signal of the portable terminal 200 through the data channel having the decrypted address. The decrypted address may be transmitted to the main communication module 110b.

A plurality of the positioning communication modules 110a may be provided in the vehicle 100, and each of the positioning communication modules 110a may receive the positioning signal from the portable terminal 200 through the data channel having the decrypted address.

The positioning communication module 110a may transmit the received positioning signal to the main communication module 110b.

When the plurality of positioning communication modules 110a is provided in the vehicle 100, the plurality of positioning communication modules 110a may receive a plurality of positioning signals, respectively, and may transmit the received positioning signals to the main communication module 110b.

Additionally, the positioning communication module 110a may receive the address of the data channel decrypted by the main communication module 110b from the main communication module 110b without decrypting the address of the data channel directly.

The positioning communication module 110a may include various local communication modules for transmitting and receiving signals using a wireless communication network in a short distance such as a Bluetooth module, an infrared communication module, an RFID (Radio Frequency Identification) communication module, a WLAN (Wireless Local Access Network) communication module, an NFC communication module, and a Zigbee communication module, and may be described as a Bluetooth module, for example.

The positioning communication module 110a may include a wireless communication interface including an antenna and a receiver for receiving positioning signals. The positioning communication module 110a may further include a signal conversion module for demodulating an analog type wireless signal received through the wireless communication interface into a digital control signal.

Also, the positioning communication module 110a may further include a processor for processing data such as decrypting an address of a data channel using an encryption key and controlling the operation of components in the positioning communication module 110a, and a memory for storing an algorithm for controlling the operation of the components in the positioning communication module 110a or storing data for a program that reproduces the algorithm.

The main communication module 110b performs pairing with the portable terminal 200 in order to register the portable terminal 200 in the vehicle 100.

The pairing is performed by receiving a pairing request signal from the portable terminal 200, giving the portable terminal 200 an encryption key, and transmitting the encryption key to the portable terminal 200, so that encrypted data may be transmitted and received thereafter using the mutually shared encryption key. Since pairing is a known technique, the detailed description is omitted.

When the pairing is completed, the main communication module 110b may store the encryption key shared with the portable terminal 200 in the memory.

The main communication module 110b according to embodiments of the present disclosure transmits the encryption key to the positioning communication module 110a so that the positioning communication module 110a may recognize the encryption key. Alternatively, the positioning communication module 110a may recognize the encryption key by snipping the encryption key stored in the main communication module 110b by the positioning communication module 110a.

The main communication module 110b may receive a search signal of the portable terminal 200 including the address encrypted with the shared encryption key from the portable terminal 200. The encrypted address may be transmitted to the positioning communication module 110a.

The main communication module 110b may receive a positioning signal from the positioning communication module 110a. The main communication module 110b may estimate the position of the portable terminal 200 using the received positioning signal. In this case, the position estimation result of the main communication module 110b may be transmitted to the vehicle controller 120.

When the plurality of positioning communication modules 110a is provided in the vehicle 100, the main communication module 110b may receive a plurality of positioning signals from the plurality of positioning communication modules 110a. The main communication module 110b may estimate the position of the portable terminal 200 based on the plurality of positioning signals. For example, the main communication module 110b may estimate the position of the portable terminal 200 using a triangulation method.

The main communication module 110b may determine the distance between the vehicle 100 and the portable terminal 200 based on the position estimation result of the portable terminal 200, and may authorize remote control of the vehicle 100 by the portable terminal 200 when the distance between the vehicle 100 and the portable terminal 200 is within a preset reference distance.

Additionally, the main communication module 110b may directly decrypt the encrypted address using the encryption key, and may transmit the decrypted address to the positioning communication module 110a.

The main communication module 110b may receive various wireless signals for the vehicle control of the portable terminal 200, such as receiving a door lock signal of the portable terminal 200 through a data channel having a decrypted address. The received vehicle control signal may be transmitted to the vehicle controller 120.

The main communication module 110b may include various local communication modules for transmitting and receiving signals using a wireless communication network in a short distance such as a Bluetooth module, an infrared communication module, an RFID (Radio Frequency Identification) communication module, a WLAN (Wireless Local Access Network) communication module, an NFC communication module, and a Zigbee communication module, and may be described as a Bluetooth module, for example.

The main communication module 110b may include a wireless communication interface including an antenna and a receiver for receiving a signal for pairing or a search signal. The main communication module 110b may further include a signal conversion module for demodulating an analog type wireless signal received through the wireless communication interface into a digital control signal.

Also, the main communication module 110b may further include a processor for processing data such as decrypting an address of a data channel using an encryption key and estimating a position of the portable terminal 200 based on the positioning signal, and controlling the operation of components in the main communication module 110b, and a memory for storing an algorithm for controlling the operation of the components in the main communication module 110b or storing data for a program that reproduces the algorithm.

The vehicle controller 120 generates control signals for controlling various components in the vehicle 100.

The vehicle controller 120 may be implemented with a memory (not shown) for storing an algorithm for controlling the operation of the components in the vehicle 100 or storing data for a program that reproduces the algorithm, and a processor (not shown) for performing the above-described operations using data stored in the memory. In this case, the memory and the processor may be implemented as separate chips. Alternatively, the memory and the processor may be implemented as a single chip.

The memory may be implemented by at least one of a non-volatile memory device such as a cache, a ROM (Read Only Memory), a PROM (Programmable ROM), an EPROM (Erasable Programmable ROM), an EEPROM (Electrically Erasable Programmable ROM), and a flash memory; a volatile memory device such as a RAM (Random Access Memory); and a storage medium such as an HDD (hard disk drive) and a CD-ROM, but is not limited thereto. The memory may be implemented as a separate chip from the processor, and may be implemented as a single chip with the processor.

The vehicle controller 120 may be implemented as an electronic controller of the vehicle 100.

The vehicle controller 120 according to embodiments of the present disclosure may receive the position estimation result of the portable terminal 200 from the main communication module 110b and authorize the remote control of the vehicle 100 by the portable terminal 200 based on the received position estimation result.

Specially, when the portable terminal 200 is within a preset reference distance from the vehicle 100, the vehicle controller 120 may authorize the remote control of the vehicle 100 by the portable terminal 200.

Additionally, the vehicle controller 120 may receive the determination result when the main communication module 110b determines that the remote control of the vehicle by the portable terminal 200 is authorized.

The vehicle controller 120 may receive a vehicle control signal from the main communication module 110b and may generate a control signal for controlling each component of the vehicle 100 based on the transmitted vehicle control signal.

For example, the vehicle controller 120 may receive a door lock signal transmitted from the portable terminal 200 through the main communication module 110b, and may generate a control signal for locking or unlocking the door lock of the vehicle 100 based on the door lock signal when the remote control of the vehicle 100 by the portable terminal 200 is authorized.

The vehicle 100 may further include an input unit (not shown) for receiving a lock or unlock command for the door lock. The vehicle controller 120 may generate a control signal for locking or unlocking the door lock based on the lock or unlock command of the door lock inputted through the input unit when the remote control of the vehicle 100 by the portable terminal 200 is authorized.

In addition, when the remote control of the vehicle 100 by the portable terminal 200 is authorized, a control signal for controlling the various vehicles 100 may be generated.

At least one component may be added or removed according to the performance of the components of the vehicle system described above. It will be readily understood by those skilled in the art that the mutual position of the components may be changed corresponding to the performance or structure of the system.

Meanwhile, some of the components shown in FIG. 3 may be software and/or hardware components such as Field Programmable Gate Arrays (FPGAs) and Application Specific Integrated Circuits (ASICs).

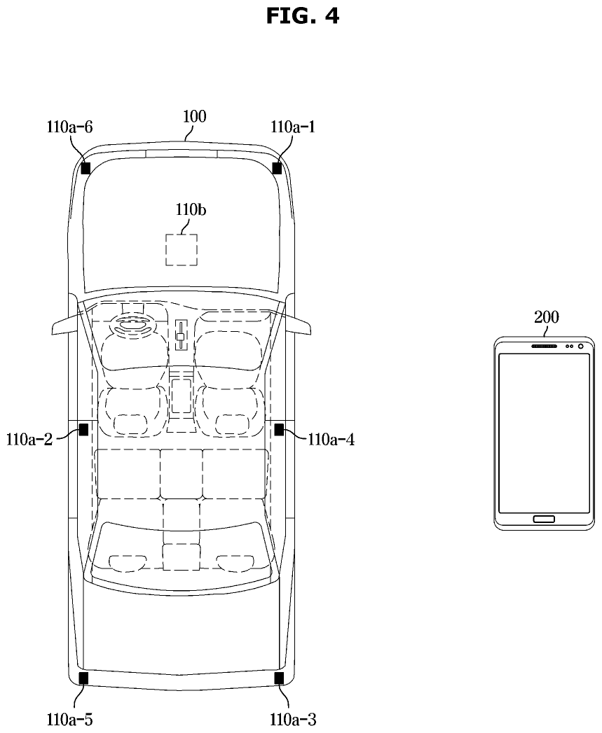

Hereinafter, a signal transmitting/receiving process between the vehicle 100 and the portable terminal 200 will be described in detail with reference to FIGS. 4 to 8.

FIGS. 4 to 8 are schematic views for explaining a signal transmission/reception process between a vehicle and a portable terminal.

The vehicle 100 may include the main communication module 110b and the positioning communication module 110a. Referring first to FIG. 4, a plurality of positioning communication modules 110a-1 to 110a-6 may be installed in the vehicle 100. The respective positioning communication modules 110a-1 to 110a-6 are installed at different positions inside or outside the vehicle 100, so that the vehicle 100 may easily grasp the position of the portable terminal 200.

FIG. 4 shows a case where six of the positioning communication modules 110a-1 to 110a-6 are installed. However, hereinafter, a case where three of the positioning communication modules 110a-1 to 110a-3 are installed for convenience of explanation will be described.

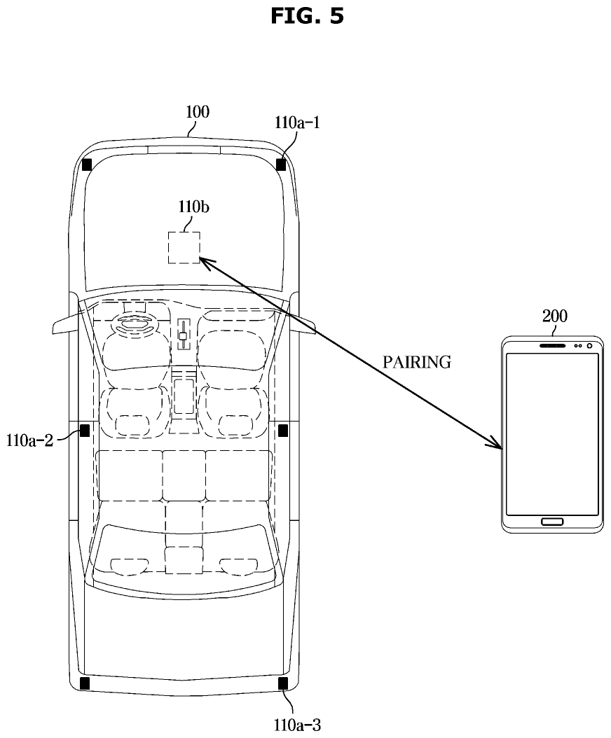

Referring next to FIG. 5, firstly, the vehicle 100 and the portable terminal 200 perform pairing.

When the pairing is completed, the main communication module 110b of the vehicle 100 and the portable terminal 200 may share the same encryption key.

Unless the encryption key is deleted, the vehicle 100 and the portable terminal 200, which have completed the pairing, respectively store the encryption key even if they are reconnected after the mutual connection is disconnected, and thus data communication may be performed without newly performing pairing.

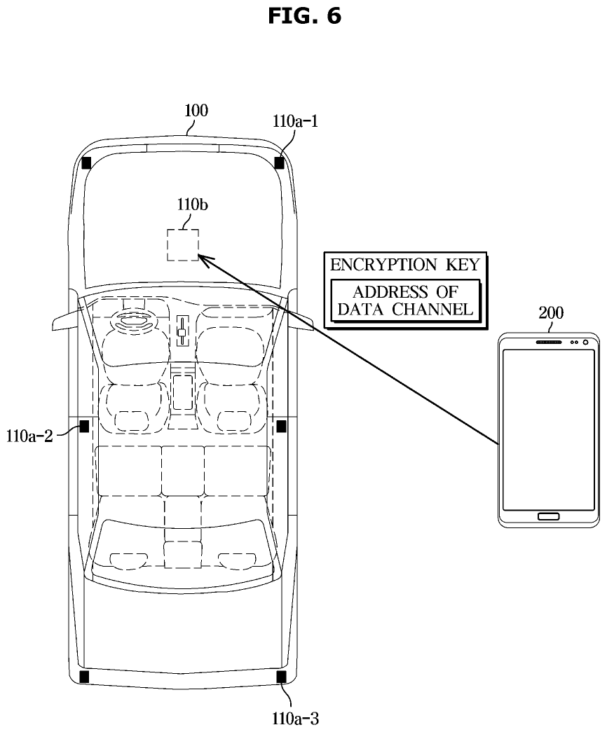

Referring next to FIG. 6, in order to transmit and receive a wireless signal to and from the vehicle 100 on a specific data channel, the portable terminal 200 having completed the pairing process may encrypt an address of a data channel to be used with the encryption key, and transmit the encrypted address as a search signal.

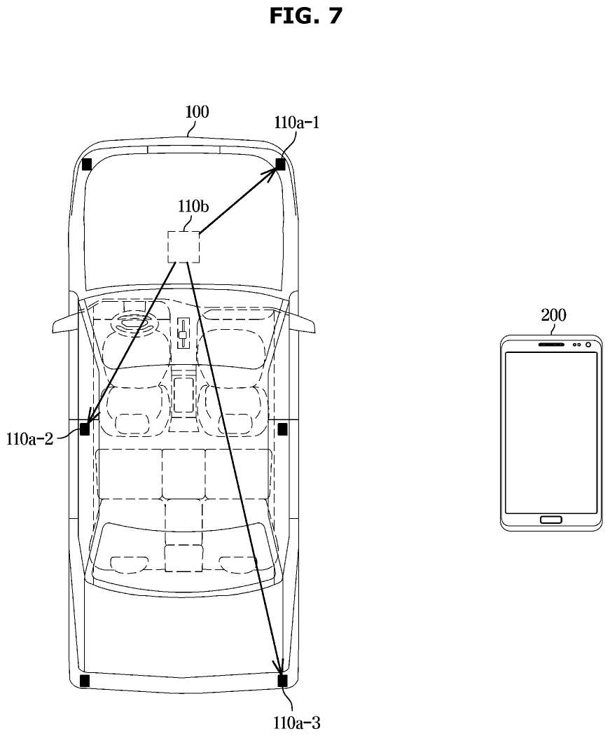

Referring next to FIG. 7, the main communication module 110b of the vehicle 100 according to embodiments of the present disclosure may transmit the address of the data channel encrypted with the encryption key and the already-shared encryption key to the plurality of positioning communication modules 110a-1 to 110a-3, and the respective positioning communication modules 110a-1 to 110a-3 may decrypt the address of the data channel using the encryption key.

Meanwhile, the main communication module 110b according to another embodiment may directly decrypt the encrypted address using the encryption key, and may transmit the address of the decrypted data channel to the plurality of positioning communication modules 110a-1 to 110a-3.

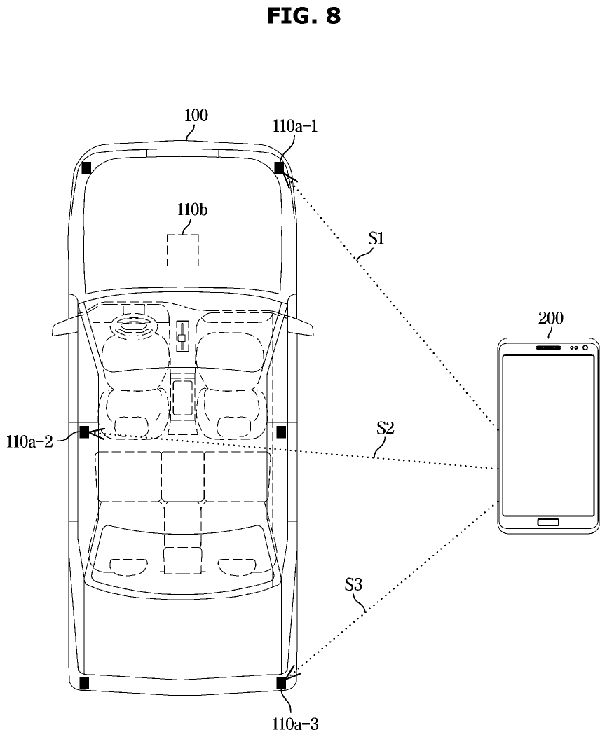

Referring next to FIG. 8, each of the positioning communication modules 110a-1 to 110a-3 may receive positioning signals S1 to S3 from the portable terminal 200 through the data channel having the decrypted address. When the positioning signals received by the respective positioning communication modules 110a-1 to 110a-3 are S1, S2, and S3, the main communication module 110b may transmit the plurality of positioning signals S1 to S3 from the positioning communication module 110a, and may estimate the position of the portable terminal 200 based on the plurality of positioning signals S1 to S3.

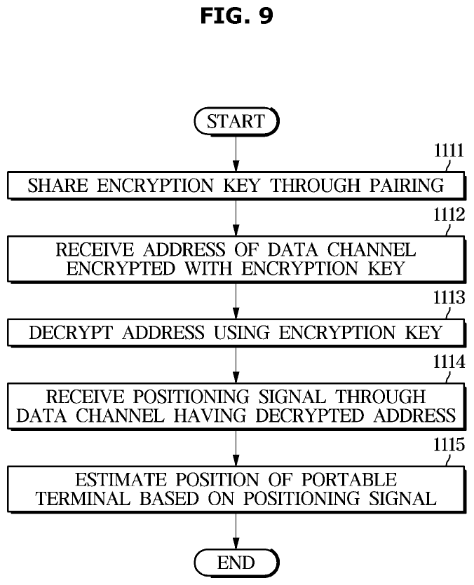

Hereinafter, a control method of the vehicle 100 according to embodiments of the present disclosure will be described with reference to FIG. 9.

FIG. 9 is a flowchart of a method for controlling a vehicle according to embodiments of the present disclosure.

First, the vehicle 100 and the portable terminal 200 perform pairing, and share the encryption key with each other when the pairing is completed (1111). The encryption key may be generated by the vehicle controller 120 of the vehicle 100, but not limited thereto, and may be generated by the portable terminal 200.

Next, the vehicle 100 may receive a search signal from the portable terminal 200, and the received search signal may include the address of the data channel encrypted with the encryption key (1112).

The vehicle 100 may decrypt the encrypted address using the shared encryption key through the pairing (1113), and may receive a positioning signal from the portable terminal 200 through a data channel having the decrypted address (1114).

When the positioning signal is received, the vehicle 100 may estimate the position of the portable terminal 200 based on the positioning signal (1115), and may determine whether to authorize the remote control of the vehicle 100 portable terminal 200 based on the result of the position estimation of the portable terminal 200.

In this case, the vehicle 100 may authorize the remote control of the vehicle 100 by the portable terminal 200 when the distance between the vehicle 100 and the portable terminal 200 is less than a reference distance.

On the other hand, if the decryption of the address is not performed or the distance between the vehicle 100 and the portable terminal 200 is longer than the reference distance, the vehicle 100 may determine that hacking has occurred and may not authorize the remote control of the vehicle 100 by the portable terminal 200.

Herein, the disclosed embodiments may be implemented in the form of a recording medium storing instructions executable by a computer. The instructions may be stored in the form of a program code and, when executed by a processor, a program module may be created to perform the operations of the disclosed embodiments. The recording medium may be implemented as a computer-readable recording medium. The computer-readable recording medium includes all kinds of recording media in which instructions which can be decrypted by a computer are stored. For example, there may be a ROM (Read Only Memory), a RAM (Random Access Memory), a magnetic tape, a magnetic disk, a flash memory, an optical data storage device, and the like.

As is apparent from the above, it is possible to prevent the risk of vehicle hacking by transmitting and receiving a positioning signal between the portable terminal and the vehicle using the encrypted address using the techniques and/or devices described hereinabove.

The embodiments disclosed with reference to the accompanying drawings have been described above. It will be understood by those skilled in the art that various changes in form and details may be made therein without departing from the spirit and scope of the disclosure as defined by the appended claims. The disclosed embodiments are illustrative and should not be construed as limiting.

1. A vehicle comprising:
a positioning communication module configured to receive a positioning signal of a portable terminal through a data channel; and
a main communication module configured to perform pairing with the portable terminal, to store an encryption key shared with the portable terminal, and to receive an address of the data channel encrypted with the encryption key from the portable terminal,
wherein the positioning communication module is further configured to snip the encryption key stored in the main communication module to determine the address of the data channel, decrypt the encrypted address using the encryption key snipped from the main communication module and to receive the positioning signal of the portable terminal through the data channel having the decrypted address, and transmit the positioning signal to the main communication module.

2. The vehicle according to claim 1, further comprising
a controller configured to authorize remote control of the vehicle, wherein
the main communication module is further configured to estimate a position of the portable terminal based on the positioning signal, and
the controller is further configured to authorize the remote control of the vehicle by the portable terminal based on the estimated position of the portable terminal.

3. The vehicle according to claim 1, further comprising
a plurality of positioning communication modules provided in the vehicle, the plurality of positioning communication modules configured to receive a plurality of positioning signals, respectively, and to transmit the plurality of positioning signals to the main communication module,
wherein the main communication module is further configured to estimate a position of the portable terminal based on the plurality of positioning signals.

4. The vehicle according to claim 3,
wherein the main communication module is further configured to estimate the position of the portable terminal using a triangulation method.

5. The vehicle according to claim 2,
wherein the controller is further configured to authorize the remote control of the vehicle by the portable terminal when the estimated position of the portable terminal is within a preset reference distance from the vehicle.

6. The vehicle according to claim 1,
wherein the main communication module is further configured to perform pairing with the portable terminal to generate the encryption key.

7. The vehicle according to claim 2, wherein
the controller is further configured to generate an encryption key and to transmit the encryption key to the main communication module when the portable terminal and the vehicle are paired.

8. The vehicle according to claim 2, wherein
the main communication module is further configured to receive a door lock signal from the portable terminal, and
the controller is further configured to control operation of the vehicle causing a door lock of the vehicle to lock or unlock based on the door lock signal when the remote control of the vehicle by the portable terminal is authorized.

9. The vehicle according to claim 2, further comprising
an input unit configured to receive a lock or unlock command of a door lock of the vehicle,
wherein the controller is further configured to control operation of the vehicle causing the door lock to lock or unlock based on the lock or unlock command received by the input when the remote control of the vehicle by the portable terminal is authorized.

10. A vehicle comprising:
a positioning communication module configured to receive a positioning signal of a portable terminal through a data channel; and
a main communication module configured to perform pairing with the portable terminal and to store an encryption key shared with the portable terminal to receive an address of the data channel encrypted with the encryption key from the portable terminal, to decrypt the encrypted address using the encryption key, and to store the decrypted address,
wherein the positioning communication module is further configured to snip the encrypted address stored in the main communication module to determine the address of the data channel, receive the positioning signal of the portable terminal through the data channel having the decrypted address snipped from the main communication module, and transmit the positioning signal to the main communication module.

11. The vehicle according to claim 10, further comprising
a controller configured to authorize remote control of the vehicle, wherein
the main communication module is further configured to estimate a position of the portable terminal based on the positioning signal, and
the controller is further configured to authorize the remote control of the vehicle by the portable terminal based on the estimated position of the portable terminal.

12. The vehicle according to claim 10, further comprising
a plurality of positioning communication modules provided in the vehicle, the plurality of positioning communication modules configured to receive a plurality of positioning signals, respectively, and to transmit the plurality of positioning signals to the main communication module,
wherein the main communication module is further configured to estimate a position of the portable terminal based on the plurality of positioning signals.

13. The vehicle according to claim 12,
wherein the main communication module is further configured to estimate the position of the portable terminal using a triangulation method.

14. The vehicle according to claim 11,
wherein the controller is further configured to authorize the remote control of the vehicle by the portable terminal when the estimated position of the portable terminal is within a preset reference distance from the vehicle.

15. The vehicle according to claim 10,
wherein the main communication module is further configured to perform the pairing with the portable terminal to generate the encryption key.

16. The vehicle according to claim 11, wherein
the controller is further configured to generate an encryption key and to transmit the encryption key to the main communication module when the portable terminal and the vehicle are paired.

17. A method of controlling a vehicle comprising:
performing, by a main communication module, pairing with a portable terminal;
snipping, by a positioning communication module, an encryption key shared with the portable terminal from the main communication module;
receiving, by the main communication module, an address encrypted with the encryption key from the portable terminal;
snipping, by the positioning communication module, the encrypted address from the main communication module;
decrypting, by the positioning communication module, the encrypted address using the encryption key snipped from the main communication module; and
receiving, by the positioning communication module, a positioning signal from the portable terminal through a data channel having the decrypted address.

18. The method according to claim 17, further comprising
authorizing, by a controller, remote control of the vehicle by the portable terminal when the positioning signal can be decrypted.

19. The method according to claim 17, further comprising
estimating, by the main communication module, a position of the portable terminal based on a plurality of positioning signals generated by a plurality of positioning communication modules, respectively, provided in the vehicle.

20. The method according to claim 18, further comprising
authorizing, by the controller, the remote control of the vehicle by the portable terminal when the portable terminal is within a preset reference distance from the vehicle.
